(19) United States
(12) Patent Application Publication
(10) Pub. No.: US 2008/0141136 A1
(43) Pub. Date: Jun. 12, 2008

(54) Clipping Synchronization and Sharing

(75) Inventors: Raymond E. Ozzie, Seattle, WA (US); Jack E. Ozzie, North Bend, WA (US); Paresh S. Suthar, Redmond, WA (US); Raman Narayanan, Kirkland, WA (US); Matthew S. Augustine, Seattle, WA (US); George P. Moromisato, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/674,046

(22) Filed: Feb. 12, 2007

Related U.S. Application Data
(63) Continuation-in-part of application No. 11/609,707, filed on Dec. 12, 2006.

(51) Int. Cl. G06F 3/00

(52) U.S. Cl. 715/723

(57) ABSTRACT

Systems, methods, data structures, and user interfaces associated with adding, storing, and using structured data clippings with a clipbook application are described. Such a clipbook application may also provide additional functionality including displaying various user interface representations of clipping data, enabling the categorization of clipping data, and communicating clipping data between various endpoints, including endpoints used by a single user and endpoints of other users.

### CROSS-REFERENCE TO RELATED APPLICATIONS

This application is a continuation-in-part of U.S. patent application Ser. No. 11/609,717, filed Dec. 12, 2006, which in turn claims priority to U.S. patent application Ser. No. 11/556,998, filed Nov. 6, 2006. Both applications are incorporated by reference herein in their entirety.

### BACKGROUND

Users of modern operating systems and applications may be accustomed to using a rich and full-featured “clipboard” to copy and paste a wide variety of data between different screens and applications. For example, users may copy text, of course, but may also copy and exchange at least some particular richer data like images in a variety of formats, text in multiple different text formats, and so on.

In particular environments, including, for example, web browsers or other similar applications, it may only be possible to interact with a clipboard using a more limited set of clipboard formats. For example, a particular web browser may enable a user to copy pieces of text, perhaps represented in text or HTML formats, as well as images, between web pages and between web pages and other applications. However, users may not be able to copy or paste using other, potentially richer, data formats.

Users may transfer data directly from one application to another using copy and paste actions, and may also sometimes copy and paste data into an intermediate application, and then copy and paste the data from the intermediate application to a destination. Such intermediate applications may store pasted data in some formats, such as text or “blobs” of data like an HTML fragment or various types of binary data (including images), but such applications also generally operate on stored structured data—which itself comprises additional information—in the same manner as they operate on text or other data formats. That is, intermediary applications may not generally take advantage of the additional information that might be available with structured data and may not provide additional functionality when operating with structured data.

### SUMMARY

The following presents a simplified summary of the disclosure in order to provide a basic understanding to the reader. This summary is not an extensive overview of the disclosure and does not identify key or critical elements of the invention or delineate the scope of the invention. Its sole purpose is to present some concepts disclosed herein in a simplified form as a prelude to the more detailed description that is presented later.

Described herein are various techniques and technologies directed toward adding, storing, and using structured data clippings in a clipping module. In addition to enabling the adding, storage, and use of clipping data, a clipping module or application might also provide additional capabilities, including displaying various user interface representations of clipping data, enabling the categorization of clipping data, and communicating clipping data between various endpoints, including endpoints used by a single user and endpoints of other users.

### DESCRIPTION OF THE DRAWINGS

FIG. 1 illustrates an exemplary generalized operational flow including various operations that may be performed when adding a piece of data to a clipbook application.

FIG. 2 illustrates an exemplary generalized operational flow including various operations that may be performed when transferring a clipping from a clipbook application.

FIG. 3 illustrates an example of a user interface that may be displayed as part of a clipbook application.

FIG. 4 illustrates an exemplary system that demonstrates some ways in which clipbook applications may share and synchronize information.

FIG. 5 illustrates an exemplary system that includes a graphical example of one mechanism for representing clipping representations of clipping data.

FIG. 6 illustrates an exemplary computer device in which the various technologies described herein may be implemented.

### DETAILED DESCRIPTION

The present invention extends to various techniques and technologies directed toward adding, storing, and using structured data clippings in a clipping module or application. In addition to enabling the adding, storage, and use of clipping data, a clipping module or application might also provide additional capabilities, including displaying various user interface representations of clipping data, enabling the categorization of clipping data, and communicating clipping data between various endpoints, including endpoints used by a single user and endpoints of other users.

Generally, the techniques described herein may enable the transfer, storage, or use of any type or kind of structured information or data with a clipping storage or “clipbook” application. As used herein, the terms “structured information” or “structured data” may refer to information or data that has additional meaning when compared to plain text. For example, a text field that contains, say, a first name or last name, might not comprise structured data. In contrast, an XML fragment that conforms to the hcard schema for representing contact information, and contains, say, name, address, phone number, email address, and so on, in a structured format in this case defined by the hcard schema, would be considered structured data. A latitude or longitude number, by itself, might not comprise structured data, but a fragment of HTML or XML that comprises a latitude or longitude value like, say, a latitude value of “37.4081 83,” and perhaps in some cases also including a human-readable version of the same value, like “N 37° 24.491,” might be considered structured data. Structured data may also in at least some embodiments include a wide variety of other information. For example, structured information may include information about the data—metadata—like its type or content type, as well as references to other or additional data, and so on. Furthermore, although this example mentions hcard, geographical structured data, HTML, and XML, it should be noted that these are only examples and that structured data may comprise a wide variety of data types and may be represented using a wide variety of data representation formats. Furthermore, a clipbook application should be interpreted generally to be any application, or any executable code, that performs at least some of the functions or operations described herein for operating with clipping data. In some implementations, a clipbook application may be a part of another application while in other implementations a clipbook application may be a separate or stand-alone application.

In just one example of transferring structured data, a user might be able to copy, say, contact information about a person from a web page to a clipboard as a single entity, where the data is perhaps represented using a common format like vcard or hcard, or some other format. If the user then wanted to move that contact information to, say, their address book, they might need to perform a single paste operation—with the entire piece of structured data—in, say, an address book web site, or in an address book application on their desktop, rather than having to copy each piece of the address as simple text and manually paste each piece of the address into a specific location or text box in an address book web site or application. After the paste operation, the destination web site or application might parse or interpret the pasted structured data to retrieve the various parts of the address and use the retrieved data to set appropriate fields in the web site or application.

Given an ability to transfer pieces of structured data by copying and pasting, or through other means, it may be useful to have a repository or storage location for such pieces of structured data. Among many benefits, the repository might provide a central place to store structured data of a wide variety of types; might provide a straightforward way to add new pieces of structured data and to identify and use pieces of structured data that are already stored in the repository; might provide visual representations of structured data; might enable the categorization and organization of structured data; might enable a user to access a store of structured data on a variety of endpoints including on multiple computing devices; and might enable a user to share structured data with other users and perhaps enable other users to update structured data and communicate changes to the user.

As an example, suppose a user is in the process of purchasing a product on a web site. The web site may support the entry of shipping and billing information through the pasting of single structured data representations of contact data that includes addresses, and may automatically populate or fill the various fields with the appropriate information when contact data is pasted into the web site.

In such a case, a user might store, say, an hcard representation of their home or billing address in a clipbook application, as a “clipping” or piece of “clipping data.” As part of the check out process on the web site, they might copy the structured representation of their address—which might be some or all of the clipping data—from the clipbook application to the clipboard and then paste the data into a web page on the web site. Because the exemplary web site supports the entry of an entire address with a single paste operation, the user avoids having to manually enter each piece of their address into separate text boxes.

The same or another clipbook application might provide a variety of additional functionality, beyond the addition of, storage of, and retrieval of pieces of structured data. For example, a user might store a variety of contact information in a clipbook application or repository—the data might include a billing address, a personal shipping address, a work shipping address, contact information for friends or colleagues, and so on. A user might also store a variety of other data in the same clipbook application, including, say, a variety of calendar items or appointments, geographical locations, and so on. The calendar items might be stored as clippings in a variety of structured data formats including the hcalendar format for representing event information. Geographical locations might be stored using a structured data format that includes latitude and longitude information, or other information. And these are just examples; the clipbook application may be able to store any type of structured data as a clipping or piece of clipping data.

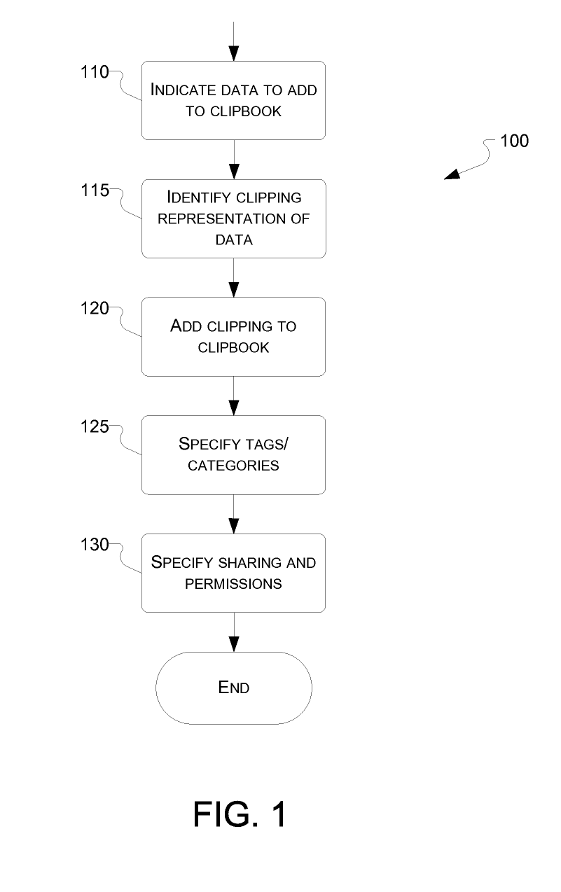

Turning now to FIG. 1, shown therein is an exemplary generalized operational flow 1 00 including various operations that may be performed when adding a piece of data to a clipbook application. The following description of FIG. 1 may be made with reference to other figures. However, it should be understood that the operational flow described with reference to FIG. 1 is not intended to be limited to being used with the elements described with reference to these other figures. In addition, while the exemplary operational flow of FIG. 1 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

In an exemplary implementation of operation 1 10, data to be added to a clipbook module or application may be indicated. This operation may be performed in a wide variety of manners depending on characteristics like the indicated data, the environment in which the data is stored or made accessible, and so on. For example and without limitation, some implementations may provide the capability of copying data from an originating location, such as an application or web page, and then pasting the data into the clipbook application. In such an implementation, or in other implementations, a user might indicate data to be added to a clipbook by performing one or more of a variety of user interface actions including selecting data in a user interface; clicking a user interface button, menu item, or other user interface element (or elements) associated with data; initiating a “drag” operation by, say, clicking and dragging a user interface element using a computer mouse or other pointing device; and so on. In implementations that use a computer-implemented clipboard as part of the process of communicating with a clipbook application, in some cases indicating data may include initiating, for example, a copy or cut operation to add the data, or some representation of the data, to a clipboard. In other implementations or cases, indicating the data to be added to the clipbook application may be performed without the use of a clipboard; in these cases the indicated data may be communicated to the clipbook application using some other means of communication, including files or file-like storage, inter-process communications, one or more networks, and so on.

As just one specific example, when a user wants to add, say, contact information to a clipbook, they may indicate perhaps the particular contact to be added to the clipbook by, say, selecting the contact in a personal information management (PIM) or other contact management application, by querying for and identifying the contact, and so on. In some implementations, the user may then initiate a copy operation and copy the contact, or at least some data associated with the contact, to a computer-implemented clipboard.

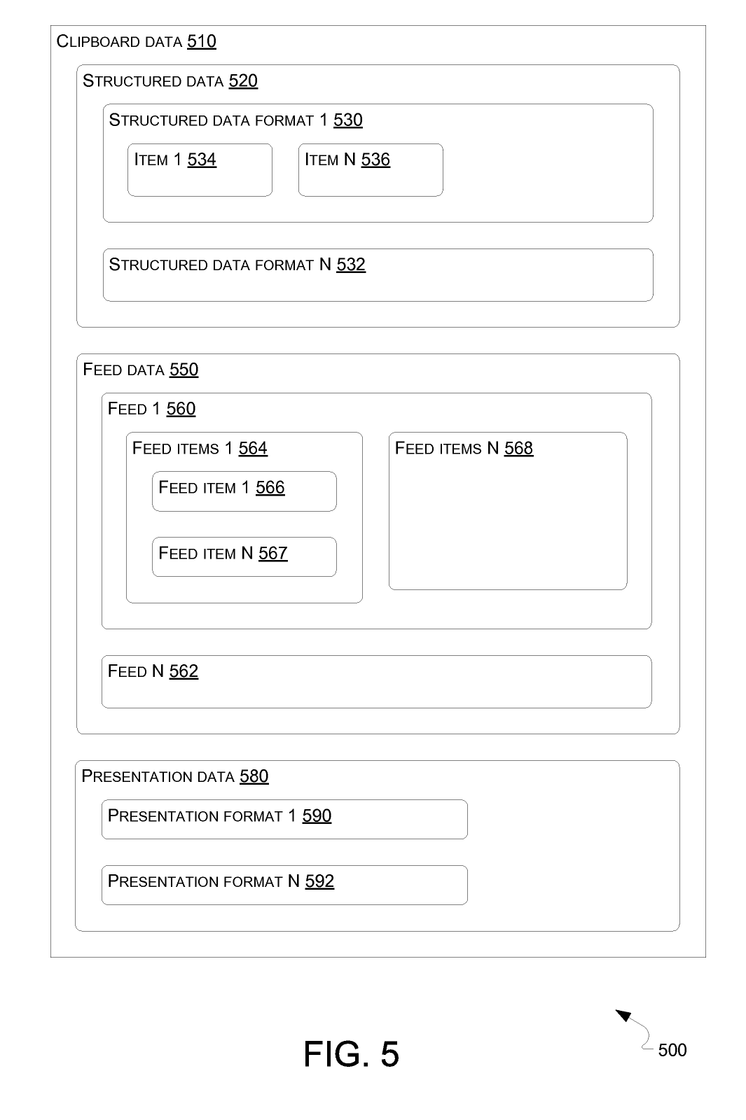

In an exemplary implementation of operation 115, a clipping representation of the indicated may be identified. In general, a clipping representation is some representation of the data to be added to a clipbook application, for either or both of transferring to (and/or from) the clipbook application and storing in the clipbook application. In some specific examples, the clipping representation may be similar to or the same as the specific clipping representation described below with reference to FIG. 5. In at least some of these implementations, the clipping representation may contain some or all of, for example, structured data, feed data, and presentation data. Further, the clipping representation might use XML, or may use one or more of a variety of other data formats, including other markup languages, binary representations, and so on.

For purposes of illustration, and as just one specific and non-limiting example, in cases where the clipping representation is the same as or similar to the clipping and transfer representation described below with reference to FIG. 5 and a user has previously indicated—perhaps in operation 110—that they want to add, say, a contact to a clipbook, the resulting clipping representation might be something like the following:

```
<?xml version=“1.0” encoding=“utf-8”?>
<liveclipboard version=“0.92”
xmlns:lc=“http://www.microsoft.com/schemas/liveclipboard”>
  <lc:data>
    <lc:format type=“vcard” contenttype=“application/xhtml+xml”>
      <lc:item>
        <div class=‘vcard’>
          <span class=‘fn n’>
            <span class=‘given-name’>John</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  <lc:data>
</liveclipboard>
```

Such a clipping representation might represent contact information in a format that may be used in some cases as part of transferring data to a clipbook application, transferring data from a clipbook application, or storing data in a clipbook application. In other implementations the clipping representation may be different.

The manner in which a clipping representation is identified may vary widely depending on characteristics including how the source of the data is implemented, how the clipping representation is transferred to a clipbook application, the manner in which the clipbook application stores the clipping data or clipping representation, and so on. For example, suppose an exemplary case where a PIM application stores contact information internally in the PIM application, perhaps in some storage format that is specific and proprietary to the PIM application, and the manner in which the clipping data is transferred to the clipbook application uses a copy to a clipboard operation in the PIM application and a paste to the clipbook application operation in the clipbook application. In such an example, as part of an implementation of operation 115, the PIM application might identify a clipping representation of the identified contact that, in some implementations, conforms to the formats introduced previously and also described in more detail below with reference to FIG. 5.

The PIM application might identify such a clipping representation when a user selects a contact, when a user initiates a copy operation, or at some other time. In this example, after the clipping representation has been identified it may be placed on a computer-implemented clipboard, so that it may be later used in another application, including a clipbook application. In other implementations and examples, the clipping representation may be identified in different ways and may be represented differently than, for example, a clipping representation that conforms to the formats described below with reference to FIG. 5. For example, even in an implementation where a clipboard is used to transfer clipping data to a clipbook application, the clipping representation may not be identified until some point in time after the data to be added is indicated or communicated to the clipbook application. For example, the clipping representation may not be identified until the data is actually added to the clipbook application, as might be performed by operation 120 in some implementations.

In at least some implementations of operation 120, the clipping or clipping representation may be added to a clipbook application. To add a clipping or clipping representation, a user might, for example, select a clipbook application and perform some type of user interface action—like choosing a menu item, initiating a paste operation, completing a “drag and drop” operation, and so on—that indicates that the identified clipping data or clipping representation should be added to the clipbook application. As part of adding the clipping data or clipping representation to the clipbook application, one or more data stores maintained, for example, by the clipbook application, may be updated. That is, if the clipbook application uses a database the clipping data or clipping representation may be added to the database, and so on.

In some cases, a clipbook application may only enable a user to add data to the clipbook application when the data is in one or more particular data formats. As just one example, the clipbook application might only enable users to add data when the data to be added is formatted using a clipping representation or data transfer format like that introduced previously and described in more detail below with reference to FIG. 5. In other cases, the clipbook application may accept some other format, or may accept multiple formats. In at least some of these cases, and possibly in the case where the clipbook application only accepts one or more particular formats, the clipbook application may translate or otherwise change the clipping data or clipping representation so that it may be stored as desired by the clipbook application.

Some clipbook implementations may support the organization of clippings, perhaps through the use of categories, tags, or the like. In such implementations, in an exemplary implementation of operation 125, one or more tags, categories, or the like, may be specified. For example, if a user adds contact information for a work colleague, they might tag the contact with “Work,” “My job,” or the like. When a user adds a friend, they might tag the contact with “Friends,” and so on. Some implementations may provide a preset list or collection of tags or categories, while other, or the same, implementations may provide the ability to dynamically define tags or categories when a new clipping is added (or at any other time). The manner in which a tag or category is associated with data added to the clipboard may vary widely, depending on characteristics like the manner in which the clipbook application is implemented, the platform on which the clipbook application is implemented, and so on. As just a few examples, a user might enter a tag or category using a keyboard, might select from a list of tags or categories using some kind of user interface element, and so on. The tags, categories, or other organizing information specified in this operation may be of any type and may have any value.

Some clipbook implementations may support the transfer or sharing of clippings with other computing devices, endpoints, users, and so on. In at least some of such implementations, in an exemplary implementation of operation 130, the data added to the clipbook application may have one or more of various sharing and permissions characteristics defined. For example, a user might specify that the particular piece of added data should not be shared in any way and should, perhaps, be stored only locally on the computing device on which it was added. In other cases, the data may be shared only with other computing devices owned, used, or otherwise associated with the user or entity that added the data. This might enable, in part and for example, data added to the clipbook application on one computer to be transferred—perhaps automatically—to another computer also used by the same user. In yet other cases, data may be identified as sharable with other people or entities. For example, particular data or clippings may be shared, but only with other users or entities that are identified, say, as “Family.” The list of entities identified as “Family” might be specified in one or more of many ways—for example, a clipbook application might utilize the manner in which contacts are categorized, so that, for example, all contacts categorized as “Family” might be able to receive and view any data or clipping that has the category or tag of “Family.” In other implementations, one might share clippings with any person or user, with any contact, and so on. Furthermore, different clippings may be shared with different users or sets of users.

In this operation, permissions associated with data may also be specified. Some clippings may be, for example, “read-only” to particular users or entities, other clippings may be editable by multiple users, and so on. As just one specific example, a user might make a particular clipping available to anyone—it might be “Public,” for example—but specify that only certain users—perhaps those identified as “Family,” “Work,” or one or more other kinds of users or entities—may modify the data. In this context, “modifying the data” might involve, for example, a second entity changing a clipping and then transferring the changed clipping, or the change itself, back to the first entity that might have added or shared the clipping.

It should be noted that the previous examples related to sharing and permissions are exemplary in nature and are provided only for purposes of explanation. In various implementations, any of a wide variety of combination of sharing and permissions are contemplated and may be implemented.

As used herein, it should be noted that a “clipboard” or “clipboard system” should be interpreted as an entity that provides functionality associated with the transfer of data between different entities, including, for example, between different applications, web pages, and so on. Some clipboard systems may provide the capabilities of adding data to a “clipboard”—perhaps through the use of a copy or cut operation—and reading data from a clipboard—perhaps through the use of a paste operation. The same or other clipboard systems may provide the ability to hold multiple pieces of data, or items, at the same time. Furthermore, the same or other clipboard systems may provide the ability to hold multiple representations or formats for a particular data item. For example, a clipboard system might have the ability to hold, say, a formatted text, plain text, and image representation of the same item. The same or other clipboard systems may enable a destination application to use or request a particular format or representation of an item. For example, a word processing application might use the formatted text representation, a simple text editor the plain text representation, and an image processing application the image representation.

It should also be noted that, as used herein in the context of transferring information, the term “copy” may also include a “cut” operation, where the difference may be that data associated with a copy operation may remain in the location from which it is being copied. In contrast, data being “cut” may be removed, through some means, from the location from which it is being copied. In both copy and cut operations, data may be placed on the clipboard—the difference may be in what happens at the location from which the data is copied or cut. For example, when a user “cuts” data associated with some region in a user interface, that region in the user interface may be cleared of visible data so it shows no information, shows default information, and so on.

Finally, it should be noted that in some implementations the transfer of information may be accomplished through cut, copy, and paste operations that may be performed using a variety of different user interface actions. For example, a user may initiate a copy operation using a keyboard, mouse, or other user interface device to select, click, or somehow indicate a “Copy” menu item; using a keyboard command like “Control-C,” or some other keyboard or other command; and so on. In some embodiments, a user may also employ one or more of a variety of other actions to transfer information, such as “drag and drop” gestures. For example, a user may select, indicate, or otherwise identify some data to be copied or cut by, say, selecting the data using computer mouse movements, and then initiate a copy or cut operation by “dragging” the selected entity or data to some other location—perhaps by clicking and holding a mouse button, and then finally “drop” the entity to initiate a paste operation at the indicated location. It should be noted that in some implementations the transfer of information using drag and drop gestures may be implemented without the use of a clipboard system—that is, for example, such gestures may transfer information without, say, changing any existing information that may already exist “on the clipboard”—but may still enable the transfer of information by dragging and dropping. As used herein therefore, copy, cut, and paste operations should be considered to encompass any set of user actions or gestures that transfer information, including those performed with a keyboard, a mouse, or any other input device.

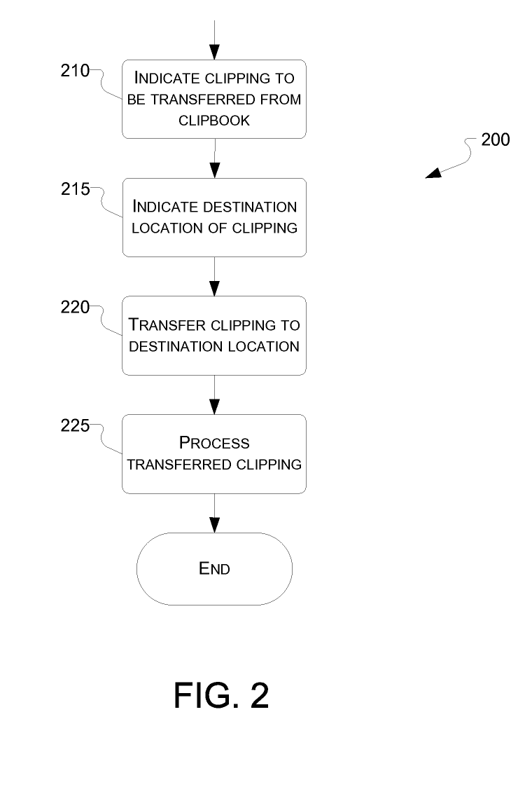

Turning now to FIG. 2, shown therein shown therein is an exemplary generalized operational flow 200 including various operations that may be performed when transferring a clipping from a clipbook application. The following description of FIG. 2 may be made with reference to other figures. However, it should be understood that the operational flow described with reference to FIG. 2 is not intended to be limited to being used with the elements described with reference to these other figures. In addition, while the exemplary operational flow of FIG. 2 indicates a particular order of execution, in one or more alternative embodiments the operations may be ordered differently. Furthermore, while the exemplary operational flow contains multiple steps, it should be recognized that in some implementations at least some of these operations may be combined or executed contemporaneously.

While the ability to add clippings to a clipbook application and to perform other operations with data stored in a clipbook application—like categorizing and sharing information—is useful, in some implementations it may also be useful to have the ability to transfer information from a clipbook application to some other application or entity. As just one example, in summary and as introduced previously, a user might choose an existing clipping that has contact information that includes their shipping address and that is stored in a clipbook application, and then transfer that clipping to, say, a web site from which the user is ordering a product.

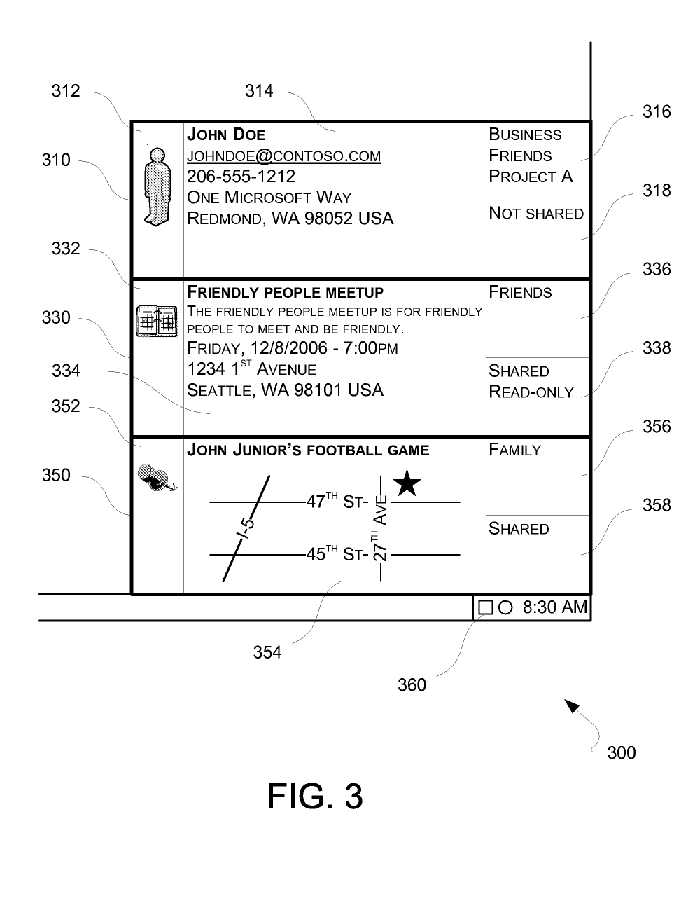

In an exemplary implementation of operation 210, the clipping to be transferred from the clipbook application may be identified in a variety of different ways. For example, a user might display a user interface associated with the clipbook application that displays some or all of the clippings stored by the clipbook application—including, for example, some or all of the user interface described in more detail below with reference to FIG. 3—and then use a keyboard, mouse, or other input device to select one or more clippings. In some implementations, this selection may then initiate other operations, such as, for example, the copying of a clipping representation of the identified clipping to the clipboard, the initiation of some other kind of communication, and so on. In implementations that use a clipboard, the clipbook application might automatically copy a clipping representation to the clipboard when, for example, a user selects a clipping in the clipbook application. In other implementations that also use the clipboard, a user may initiate the copy operation manually in a variety of ways, including by choosing a “Copy” menu item, pressing one or more keys on a keyboard, initiating a “drag” operation (including in implementations where “drag and drop” operations may operate without changing the information on the clipboard or using a clipboard), and so on.

In some implementations of operation 210, a clipping representation of the selected clipping data that perhaps uses a format like that described below with reference to FIG. 5, or some other format, may be identified. In other implementations a clipping representation may be identified as part of a later operation, including some implementations of operation 215 or operation 220. In some implementations, the clipbook application itself may store clippings by storing their clipping representations, and so may identify a clipping representation for a particular clipping by retrieving the stored clipping representation.

In an at least some implementations of operation 215, the destination of the clipping indicated in operation 215 may be indicated, also in one or more of a variety of manners. For example, in some implementations a user might switch from the clipbook application to another application and then indicate some location or part of the other application as the destination of the clipping. In another exemplary implementation, a user may choose from a list of applications or parts of applications, and so on. The same or other destination applications may define, for example, one or more “clipboard interaction regions” that each may be associated with particular data, particular elements of the application or of the application user interface, and so on. For example, a web site might define a clipboard interaction region that is associated with a billing address, another clipboard interaction region that is associated with a shipping address, and so on. It might implement these clipboard interaction regions as, say, an HTML button, image, or using some other user interface representation. With at least some of such destination applications, a user might use a clipboard interaction region, or some other user interface element, to indicate to where a clipping on the clipboard (perhaps represented using a clipping representation) should be transferred.

In an exemplary implementation of operation 220, the clipping may be transferred to the indicated destination. The manner in which this operation is implemented may vary widely depending, as before, on characteristics like the platform on which the clipbook application and/or destination are implemented, and so on. Applications may have the capability of handling the transfer of a clipping in a variety of ways. For example, when a clipboard is used to transfer a clipping representation, some applications may handle a paste operation—including paste operations initiated by the use of menu items, keyboard commands, “drop” gestures, and so on—by retrieving some or all of the information from the clipping representation and then processing such information, where processing the information is described below with reference to operation 225.

Finally, in one or more exemplary implementations of operation 225, the destination application may process the transferred clipping data in one or more of a variety of ways, depending on characteristics like the nature of the transferred data, the purpose or use of the destination application, and so on. For example, if a user transfers a clipping that contains contact information including an address and has indicated, say in operation 215, that the destination of the clipping is a “Bill to Address” portion of a user interface, part of processing the transfer of the clipping might involve retrieving contact and address information from the transferred clipping. For example, in cases where the clipping uses a clipping representation like that described below with reference to FIG. 5, part of this operation might involve parsing XML information that comprises the clipping representation and identifying the relevant parts of, for example, an hcard or hcards in the clipping representation, like the street address, the city, and so on. When relevant data has been identified, the processing may place the data in multiple text boxes on the order page. In other implementations, clipping data may be processed in any other fashion—it may be stored in a database, used to update a user interface in any fashion, transferred to another application, transferred to another portion of the same application, and so on.

Turning now to FIG. 3, shown therein is one example of a user interface 300 that may be displayed as part of a clipbook application. This description of FIG. 3 may be made with reference to other figures. However, it should be understood that the elements described with reference to FIG. 3 are not intended to be limited to being used with the elements described with reference to other figures. In addition, while the exemplary diagram in FIG. 3 indicates particular elements, in some implementations not all of these elements may exist, and in some implementations additional elements may exist. Furthermore, it should be understood that the exemplary graphical representations of the systems and user interfaces shown in FIG. 3, and in other figures included herein, are provided only for purposes of discussion, and in no way should be construed as limiting the scope of the techniques described herein to any particular graphical or other representation. Furthermore, the user interface is exemplary and may be implemented in a variety of ways, using a variety of technologies, with a variety of differences from the exemplary user interface, and so on, without departing from the elements of the user interface as described herein.

The exemplary user interface 300 shows just one manner in which three user interface representations of clippings 310, 330, and 350 may be displayed in a clipbook application. To display this user interface, a user might, as just one example, click or double-click an icon that is associated with the clipbook application, like the icon 360 shown in a system tray area of an operating system user interface. As a result of such interaction, or as a result of some other action or operation (including the use of keyboard commands, and so on), one or more clippings might be displayed. As shown, the clipbook application only contains three displayed clippings. However, as will be appreciated by those skilled in the art, the user interface may not display, for example, all of the clippings stored by the clipbook application. For example, because of space, size, or other limitations, the user interface may only display a portion of the clippings, may provide a “scroll bar” or one or more other user interface elements to enable the viewing of a particular clipping, and so on.

Each user interface representation of a clipping 310, 330, and 350 may contain one or more user interface elements that display information associated with the clipping. For example, the user interface representation of the clipping 310 might comprise an image 312, a clipping visualization 314, tag information 316, and sharing and permission data 318. The user interface representations of clipping 330 and the user interface representation of clipping 350 are shown in this exemplary user interface as containing the same user interface elements, although with different data—that is, for example, the user interface representation of clipping 330 also is shown as having the image 332, but the image itself is different. The user interface representation of clipping 330 also has a clipping visualization 334, tag information 336, and sharing and permission data 338. Similarly, the user interface representation of the clipping 350 is shown as having an image 352, a clipping visualization 354, tag information 356, and sharing and permission data 358. While the three user interface representations of clippings described with reference to FIG. 3 have the same elements, in some implementations only certain user interface elements may be displayed for certain clippings. As just one example, a particular clipping might have an image, for example, while another clipping does not, and so on.

Taking the user interface representation of the clipping 310 as an example, this user interface may be displayed when, for example, the associated clipping data and/or clipping representation contains contact data. In just one example, such a clipping might have been created as a result of a user adding a clipping that contains, say, hCard data, to the clipbook application. The image 312 may be used, for example, by the clipbook application when the clipping contains contact information. Of course, another image (or no image at all) might be used instead. In some implementations, a clipbook application might store images and, automatically perhaps, associate the images with particular types of clippings. In the same or other implementations, a user might choose an image, or an image might be selected in some other manner.

The clipping visualization 314, and “clipping visualizations” in general, may be defined as a user interface representation of a particular clipping, piece of clipping data, or clipping representation. That is, a clipping visualization may be a way of displaying a visual representation of a clipping. Depending on the data in the clipping, the nature of the visualization may vary widely. For example, a clipping visualization for a clipping that contains contact information may in some cases appear like the clipping visualization 314, and display, for example, name, street address, city, and so on. A clipping visualization for event information—as might be represented using the hcalendar format, as just one example—might appear in some implementations like the clipping visualization 334, with an event title, an event description, the time and duration of the event, and so on. A geographical location, like one that includes latitude and longitude information, might be represented in some cases using a clipping visualization like the clipping visualization 354, which shows a title describing the location, and a map. In many cases, the visualization may only display some of the information that is actually in the clipping or that is associated with a clipping representation of the clipping. This might be done to simplify the visual representation, or for other reasons. As just one example, a clipping might contain multiple addresses, multiple phone numbers, and so on, but a visualization might only display a subset of such information. In such cases, or in other cases, a user may be able to interact with the visualization or with the general user interface representation of the clipping to see, for example, all of the data associated with the clipping, to see a complete clipping representation stored by the clipbook application, and so on.

In implementations where a clipping or clipping representation may have one or more associated tags, categories, or the like, the user interface may in some cases display some or all of this categorization information, in some form. For example, the tag information 316 might indicate that the clipping 310 is tagged or categorized as being part of the “Business,” “Friends,” and “Project A” categories. In some clipbook implementations, such tags and categories might be used to organize clippings, to enable a user to filter and perhaps only display clippings with particular tags or categories, and so on.

An exemplary user interface might also display sharing and permission data, such as the sharing and permission data 318 associated with the user interface representation of the clipping 310. Such data might indicate, for example, how each clipping is shared (or not shared), might also possibly show how clippings can be updated by the user or by other users, and so on. For example, the sharing and permission data 318 that displays “Not shared” might indicate that the clipping 310 is a piece of clipping data that is not shared between any computing devices or endpoints, including even those computing devices or endpoints owned, used, or associated with the same user. In the same or other implementations, clippings may, for example, always be shared between endpoints associated with a particular user but might not shared, by default, with other users. In contrast, the sharing and permission data 338 and sharing and permission data 358, both displaying “Shared,” might indicate that the associated clipping is shared, for example, with other users. As introduced previously, the particular users with which a clipping is shared might be defined in one or more of a variety of ways. For example, clippings with certain types of data, clippings that are designated by a user, clippings that are designated in some other way, may be shared with anyone (that is, they might be public). Other clippings may be shared with a particular set of users, with a single other user, and so on. In some implementations, the user or users with which a particular clipping may be shared might be defined explicitly, or might be implied or determined using, for example, other characteristics of the clipping. For example, a clipping that has the tag or category “Family” might be shared with other users that are part of that family.

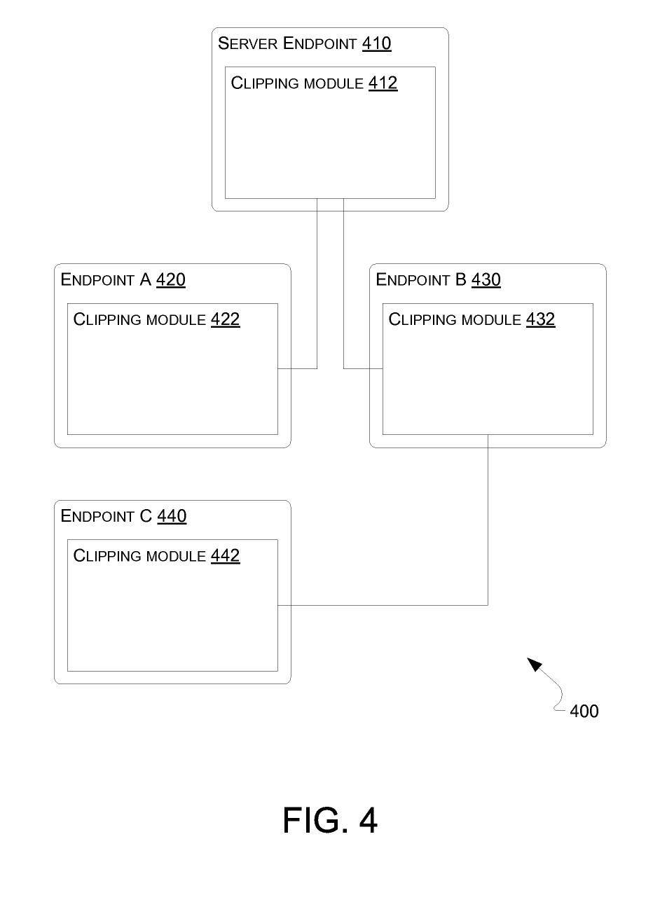

The sharing and permission data may also in some implementations define how a particular instance of the clipbook application or a particular user may modify a clipping. For example, the sharing and permission data 338 contains the text “Read-only,” which may indicate, for example, that the clipping cannot be changed—perhaps because it was received or synchronized from some other user, or for some other reason. In this example, specifically, the organizer of the event associated with the user interface representation of the clipping 330 may have published the clipping with event information. After the clipping is synchronized to the user's clipbook, the event information is shown in the user's clipbook via the user interface representation of the clipping 330. In such a case, it may not be appropriate for the user to change the details of the event—after all, the user is not the event organizer—and so the clipping may be read-only. In other cases, a clipping shared with other users may be changed by different users. In some of these implementations, changes made by other users may then be transmitted to yet other users, including to the user that originally created or shared the clipping. This might be the case, for example, when members of a family keep a shared or common list of, say, contacts, and all members of the family may update contact information for members of the list. In some implementations, one or more lists or sets of clippings themselves may be synchronized between endpoints. In at least some of such cases, users may add or remove clippings from a list, but might not modify the clippings themselves. (Publishing and synchronizing clippings between endpoints, computing devices, users, and so on, is discussed in more detail below, with reference to FIG. 4.)

It should be noted that although different elements of a user interface representation of a clipping are shown in FIG. 3 as being part of the same portion of the exemplary user interface, different elements of each user interface representation of a clipping might also or instead be represented in separate user interfaces or in separate user interface elements. In addition, it should understood that the user interface representation of the clippings 310, 330, and 350 comprise just one possible user interface associated with just some exemplary clippings. A user interface representation of a clipping may in some implementations appear the same as or similar to the user interface representations of clippings 310, 330, and 350, and in other implementations may appear differently.

Turning now to FIG. 4, shown therein is an exemplary system 400 that demonstrates further some ways in which clipbook applications may share and synchronize information. This description of FIG. 4 may be made with reference to other figures. However, it should be understood that the elements described with reference to FIG. 4 are not intended to be limited to being used with the elements described with reference to other figures. In addition, while the exemplary diagram in FIG. 4 indicates particular elements, in some implementations not all of these elements may exist, and in some implementations additional elements may exist.

As shown, the exemplary system 400 comprises a server endpoint 410, an endpoint A 420, an endpoint B 430, and an endpoint C 440. Each endpoint may in some implementations include a clipping module, such as the clipping modules 412, 422, 432, and 442. Generally speaking, a clipping module may implement some or all of the functionality described herein as being associated with a clipbook application, including implementing the operational flow 100, the operational flow 200, and providing a user interface like, for example, the user interface 300. In some implementations, a clipbook application may incorporate the functionality provided by a clipping module.

In some cases, a user may use a clipping module or a clipbook application on a single computing device. In other cases it may be useful to share some or all of the clippings that are created, for example, on one computing device, with other computing devices.

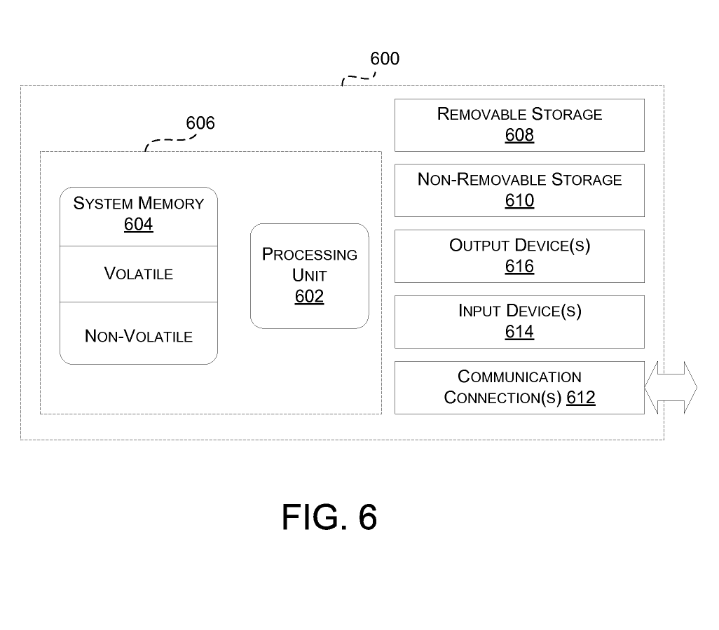

In one type of sharing, a single user may use more than one computing device and may want to maintain the same set of clippings on all of the computing devices or endpoints associated with the user. For example, endpoint B 430 and endpoint C 440 may both be computing devices—like desktop computers, laptop computers, mobile phones, and so on—that are used by the same user. (An endpoint or computing device may be, in some implementations, the same as or similar to the computing device described below with reference to FIG. 6.) When the user adds a new clipping using the clipping module 432 on endpoint B 430, in some implementations, and perhaps automatically or at the control of the user, that clipping may be synchronized or shared with any or all of the clipping modules on the user's other computing devices, including, in this example, the clipping module 442 implemented on the computing device associated with the endpoint C 440. Because the clipping is synchronized between both endpoints, the user may use endpoint C and still access the clipping that was added on endpoint B.

Clippings may be synchronized or shared between endpoints in a wide variety of ways and using any number of synchronization schemes, communications means, and so on. As just one example, at least some endpoints might synchronize clippings—perhaps by synchronizing clipping representations of the clippings—using a protocol like Simple Sharing Extensions (SSE). SSE may provide the ability to synchronize data including XML, as well as other data formats, using feeds including RSS (Really Simple Syndication or Rich Site Summary) feeds, Atom feeds, or other types of feeds. With SSE, an endpoint—like endpoint B in the previous example—may publish one or more feeds using, say, RSS. When used to synchronize clippings, the feed (or feeds), might contain an item for each clipping, along with synchronization information defined by SSE. In implementations that use clipping representations with a format like that described below with reference to FIG. 5, each item in a feed might include a clipping representation itself. To incorporate or obtain clippings, another endpoint—like endpoint C in the previous example—might subscribe to the feed published by the endpoint and, using the information in the feed and the SSE data also in the feed, may be able to determine when new items are added, when existing items are changed or deleted, and so on.

Some synchronization protocols, including SSE, may also provide the ability to perform “bi-directional” synchronization, where, say, a piece of data may be modified (or new data may be added or existing data may be deleted) on either endpoint, after which the change may be incorporated on the other endpoint. For example, with reference to the elements of FIG. 4, when using bi-directional synchronization, a user might be able to add new clippings, delete clippings, or change existing clippings on both endpoint B 430 and endpoint C 440, and at least some, or all, of the changes made on one endpoint may then be reflected on the other endpoint.

SSE, as well as at least some other synchronization methods, may support “peer-to-peer” topologies, where endpoints may share and synchronize data without the use of an organizing endpoint, such as a central server. When endpoint B 430 and endpoint C 440 synchronize clippings directly with each other, they may use such a peer-to-peer arrangement. Various synchronization schemes may also, or only, support synchronization through some kind of organizing, central, or server endpoint. For example, SSE may also support synchronization with one or more organizing servers. For example, endpoint A 420 may synchronize some or all of the clippings managed by the clipping module 422 with the clipping module 412 implemented on the server endpoint 410. The clipping module 432 implemented on endpoint B 430 may then synchronize some or all of the same clippings with the server endpoint 410, and in such a way obtain the clippings originally added by endpoint A. Bi-directional synchronization may also be implemented between endpoints through a server. It should be noted that although only a single server endpoint 410 is shown, in at least some implementations, endpoints may also synchronize with multiple servers.

In some implementations, as introduced previously with reference to FIG. 3, clippings may only be synchronized between certain endpoints, certain users, and so on. Also as introduced previously, some clippings may be synchronized while others are not, as defined by, for example, individual users, particular policies or rules, and so on.

Turning now to FIG. 5 shown therein is an exemplary system 500 that includes a graphical example of one mechanism for representing clipping representations of clipping data. In addition to being used, for example, to persist or store clipping data, clipping representations described with reference to FIG. 5 may also be used as transfer representations when, say, transferring clippings between endpoints, and so on. In some cases, the formats described with reference to FIG. 5 may be referred to as formats that conform to the “Live Clipboard” schema.

The exemplary system 500 may contain clipboard data 510, structured data 520, feed data 550, and presentation data 580. Any or all of the structured data, feed data, and presentation data may include references in at least some implementations. Structured data may be associated with one or more structured data formats, such as structured data format 1 530 and structured data format N 532. A structured data format may contain one or more items, such as item 1 534 and item N 536. Feed data may be associated with feeds like feed 1 560 and feed N 562, while a feed may be associated with some number of sets of feed items, such as feed items 1 564 and feed items N 568. A set of feed items, like feed items 1 564, may be associated with some number of feed items, like feed item 1 566 and feed item N 567. Finally, presentation data 580 may be associated with one or more presentation formats, like presentation format 1 590 and presentation format N 592. This description of FIG. 5 may be made with reference to other figures. However, it should be understood that the elements described with reference to FIG. 5 are not intended to be limited to being used with the elements described with reference to other figures. In addition, while the exemplary diagram in FIG. 5 indicates particular elements, in some implementations not all of these elements may exist, and in some implementations additional elements may exist.

A clipping representation of data may be embodied using a wide variety of formats. In some implementations, a clipping representation may include some structured representation of the data itself (which may itself include references to additional data), feed or subscription information that may be associated with one or more references to additional data and about the structured data or about other data, and additional presentation or display representations of the structured data.

In some implementations, a clipping representation may be represented using a markup language, like XML, for example, or some other representation. It should be noted that while the clipping representation, the system 500, and the clipboard data 510 may be described herein with reference to XML elements, XML attributes, and so on, the use of XML is not required and any description of such use herein is provided for exemplary purposes only. The clipping representation may be represented in any number of a wide variety of alternate formats. Furthermore, while particular elements, attributes, and so on, may be referred to for exemplary purposes using a particular name, such elements, attributes, and so on, may be referred to using any name.

In some implementations, the clipboard data 510 may contain header information as well as one or more of different types of data, including the actual structured data, feed data, and presentation data. In general each of these types of data may refer to the same information, but in different formats. One purpose of providing multiple formats in this manner may be to make it more likely that a destination may find data appropriate for its use.

When represented using a markup language, perhaps like XML, the structure of the clipboard data 510 might be the same as or similar to the following:

| | |
|---|---|
| <liveclipboard> | |
| <lc:data> | 0 or 1 elements |
| <lc:farmat> | 1 or more elements |
| <lc:item/> | 1 or more elements |
| </lc:format> | |
| </lc:data> | |
| <lc:feeds> | 0 or 1 elements |
| <lc:feed> | 1 or more elements |
| <lc:feeditems> | 0 or 1 elements |
| <lc:feeditem> | 0 or more elements |
| </lc:feeditems> | |
| </lc:feed/> | |
| </lc:feeds> | |
| <lc:presentations> | 0 or 1 elements |
| <lc:format/> | 1 or more elements |
| </lc:presentations> | |
| </liveclipboard> | |

In some implementations, the “liveclipboard” element may be associated with the clipboard data 510, and the “data”, “feeds”, and “presentations” elements, and their child elements, may be associated, respectively, with the structured data 520, feed data 550, and presentation data 580, and their child elements, as described with reference to FIG. 5. In addition, in this example data, the use of the string “Ic:” might indicate a particular XML namespace, perhaps including a namespace related to transferring structured data using a clipboard as described herein.

In some cases, header or other information may be associated with the clipboard data 510. This data may be associated with some or all of “version”, “source”, and “description” attributes, as well as other attributes. The “version” attribute may represent the version of the clipboard data format used in a particular instance of the clipboard data. The “source” attribute may represent a reference, like a URL, to the source provider of the clipboard data content. And the “description” attribute may represent a human readable description of clipboard data content.

In some implementations, the clipboard data may be associated with at least one of structured data 520, feed data 550, and presentation data 580. In the same or other implementations, the clipboard data may be associated with more than one of these elements, including some implementations where all three of the elements, or possibly other elements, may be included.

The first set of data that may be included is the structured data itself, which, in some implementations, may be associated with the structured data 520. In the same or other implementations the structured data 520 may be associated with data represented using defined data formats, such as hcard and vcard for representing contact information, hcalendar and iCal for representing event information, and so on. However, any defined format or structured data may be used or associated with the structured data 520.

When the clipboard data 510 contains structured data 520, it may be represented, for example, in a manner similar to or the same as the following:

| | |
|---|---|
| <lc:data> | 0 or 1 elements |
| <lc:format> | 1 or more elements |
| <lc:item/> | 1 or more elements |
| </lc:format> | |
| </lc:data> | |

When represented like this, the “format” element may correspond to the structured data format 1 530 and the structured data format N 532, while the “item” element may correspond to the item 1 534 and the item N 536.

A structured data format, like structured data format 1 530 , may define the format of the child “item” elements, like item 1 534 and item N 536, with which it is associated. A structured data format may be associated with some or all of the “contenttype”, “type”, and “encoding” attributes, as well as other attributes. The “contenttype” attribute may represent the content type of data for the contained “item” elements. For example, this attribute may contain data defined by the Internet Assigned Names Association (IANA), like “text/calendar”, “application/xhtml+xml”, and so on. The “type” attribute may represent a schema or format type of the data for the contained “item” elements. This may be useful, for example, if an IANA format identifier provided may not be sufficient to completely determine the type. For example, when the “contenttype” attribute has a value of “text/calendar” there may be sufficient information to determine that the data associated with an “item” element is formatted using the iCal standard. In contrast, when the “contenttype” attribute has a value such as “application/xhtml+xml”, additional information may be necessary to determine the format of the data in the “item” element. For example, in this case, the “type” attribute might have a value of “vevent”, which might indicate that the data is formatted using the hcalendar standard. Finally, an “encoding” attribute may represent how the data associated with the “item” elements is encoded.

In some implementations, when multiple formats are provided, such as with multiple instances of structured data format 1 530 and structured data format N 532, it may be useful to order the formats in some fashion. For example, “higher fidelity” formats—formats that may provide more data, for example—might be ordered before “lower fidelity” formats that do not provide as much data. (Lower fidelity formats may be more widely accepted by destinations, and so still may be preferable for some uses, or for some applications, web pages, and so on.)

After the format of the data is defined, for example, using a structured data format, like structured data format 1 530, one or more items that are represented using that format may be provided. These items may correspond, for example, to the item 1 534 and item N 536. In some representations, these items may be associated with “item” elements that are perhaps located as children of “data” and “format” elements.

An “item” may represent data itself and may be associated with some or all of “description” and “ref” attributes, as well as other attributes. The “description” attribute may represent additional data defined by the user or application. The “ref” attribute may contain a reference, for example a URL, associated with the item.

The “item” element may also contain data itself. For example, when using XML, if the data can be represented as well-formed XML data that uses, say, the UTF-8 encoding, then the XML corresponding to the data may be appended as a child of the “item” element. In some other cases, for example when the data may not be represented as well-formed UTF-8 XML data, the data may reside in a CDATA section for the “item” element, optionally encoded in the format described by the “encoding” attribute of the enclosing “format” element.

Data associated with either or both of the “format” and “item” elements may include both “by-value” and “by-reference” data. That is, the actual data itself may be included, for example, in the “item” element. Alternatively, or in addition to the actual data, a reference to the data or to additional data may be included. That is, an “item reference” may be included in the data for a structured data item. In some implementations, for example, the reference to the data may be stored using the previously introduced “ref” attribute. For example, in an item that contains information about a single contact or person, a by-value copy of the data might be provided as part of the “item” element itself, and a reference to that contact—perhaps as a URL—might be provided using the “ref” attribute of the “item” element. In some cases, for a particular item, only by-value data may be provided, while in other cases only by-reference data may be provided, and while in yet other cases, both by-value and by-reference data may be provided.

In some implementations, when there are multiple structured data formats, the ordering of items beneath each format may indicate how items correspond to each other. For example, if clipboard data 510 includes two structured data formats X and Y, corresponding in some implementations to two “format” elements, the first “item” element of format X may correspond to the first “item” element of format Y. That is, the first “item” element for each format may refer to the same item, but represented in different formats. Furthermore, in some implementations, when feed data—discussed in more detail below—exists, including feed data that includes feed items, the ordering of “item” elements may correspond to the ordering of “feeditem” elements, which may enable the correspondence of items to their location in a feed.

As just one example, suppose that the clipboard data includes contact information for a particular contact, and that the contact information itself is represented using the hcard standard. In such an example, the contact information itself may be represented as follows:

```
<div class=‘vcard’>
  <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

A corresponding clipboard data representation might consist of the following data:

```
<?xml version=“1.0” encoding=“utf-8”?>
<liveclipboard version=“0.92”
xmlns:lc=“http://www.microsoft.com/schemas/liveclipboard”>
  <lc:data>
    <lc:format type=“vcard” contenttype=“application/xhtml+xml”>
      <lc:item>
        <div class=‘vcard’>
          <span class=‘fn n’>
            <span class=‘given-name’>John</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  </lc:data>
</liveclipboard>
```

As another example, suppose that two contacts—each represented using hCard—are to be represented as clipboard data. The contacts themselves might be represented as follows:

```
<div class=‘vcard’>
  <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
<div class=‘vcard’>
  <span class=‘fn n’>
    <span class=‘given-name’>George</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

And the corresponding clipboard data representation might be as follows:

```
<?xml version=“1.0” encoding=“utf-8”?>
<liveclipboard version=“0.92”
xmlns:lc=“http://www.microsoft.com/schemas/liveclipboard”>
  <lc:data>
    <lc:format type=“vcard” contenttype=“application/xhtml+xml”>
      <lc:item>
        <div class=‘vcard’>
          <span class=‘fn n’>
            <span class=‘given-name’>John</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
      <lc:item>
        <div class=‘vcard’>
          <span class=‘fn n’>
            <span class=‘given-name’>George</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  </lc:data>
</liveclipboard>
```

As discussed previously, the clipboard data may include alternate representations or formats for a single item. As one example, suppose that an event may be represented using both the iCal and hCalendar standards. With such an example, the iCal data might be like the following:

BEGIN:VCALENDAR
METHOD:PUBLISH
VERSION:2.0
BEGIN:VEVENT
URL:http://www.microsoft.com/events/E1-001-000629872-2
DTSTART:20060208T180000
DTEND:20060208T180000
DTSTAMP:20060119T184157Z
SUMMARY:The Bellevue Vegetarian February Meetup
DESCRIPTION:Let's all get together and meet over a great veggie
dinner at Teapot
Vegetarian House in Redmond!
UID:E1-001-000629872-2
LOCATION:Bellevue\,Washington 98004
END:VEVENT
END:VCALENDAR

In the same example, the corresponding hCalendar data might be like the following:

```
<div class=‘vevent’>
  <a class=‘url’ href=‘http://www.microsoft.com/events/E1-001-
  000629872-2’>
    <span class=‘summary’>The Bellevue Vegetarian February
    Meetup</span>
  </a>
    <div class=‘description’>Let&#39;s all get together and meet over a
great veggie dinner at Teapot Vegetarian House in Redmond!</div>
  <div>Start Date: <abbr class=‘dtstart’
title=‘20060208T180000’>February 8, 2006</abbr></div>
  <div>End Date: <abbr class=‘dtend’
title=‘20060208T180000’>February 8, 2006</abbr></div>
  <div>Location: <span class=‘location’>Bellevue,Washington
  98004</span></div>
  <div>UID: <span class=‘uid’>E1-001-000629872-2</span></div>
  <div>Last Updated: <abbr class=‘dtstamp’
title=‘20060119T184157Z’>January 19, 2006</abbr></div>
</div>
```

Both of these formats might be represented in clipboard data in a manner similar to or the same as the following:

```
<?xml version=“1.0” encoding=“utf-8” ?>
<liveclipboard version=“0.92”
xmlns:lc=“http://www.microsoft.com/schemas/liveclipboard”>
  <lc:data>
    <lc:format type=“vcalendar” contenttype=“application/xhtml+xml”>
      <lc:item>
        <div class=‘vevent’>
          <a class=‘url’ href=‘http://www.microsoft.com/events/E1-001-000629872-2’>
            <span class=‘summary’>The Bellevue Vegetarian February Meetup</span>
          </a>
          <div class=‘description’>Let&#39;s all get together and meet over a great veggie
dinner at Teapot Vegetarian House in Redmond!</div>
          <div>Start Date: <abbr class=‘dtstart’ title=‘20060208T180000’>February 8,
2006</abbr></div>
          <div>End Date: <abbr class=‘dtend’ title=‘20060208T180000’>February 8,
2006</abbr></div>
          <div>Location: <span class=‘location’>Bellevue,Washington 98004</span></div>
          <div>UID: <span class=‘uid’>E1-001-000629872-2</span></div>
          <div>Last Updated: <abbr class=‘dtstamp’ title=‘20060119T184157Z’>January 19,
2006</abbr></div>
        </div>
      </lc:item>
    </lc:format>
    <lc:format contenttype=“text/calendar”>
      <lc:item>
        <![CDATA[
          BEGIN:VCALENDAR
          METHOD:PUBLISH
          VERSION:2.0
          BEGIN:VEVENT
          URL:http://www.microsoft.com/events/E1-001-000629872-2
          DTSTART:20060208T180000
          DTEND:20060208T180000
          DTSTAMP:20060119T184157Z
          SUMMARY:The Bellevue Vegetarian February Meetup
          DESCRIPTION:Let's all get together and meet over a great veggie dinner at Teapot
Vegetarian House in Redmond!
          UID:E1-001-000629872-2
          LOCATION:Bellevue\,Washington 98004
          END:VEVENT
          END:VCALENDAR
        ]]>
      </lc:item>
    </lc:format>
  </lc:data>
</liveclipboard>
```

Some clipping representations and clipboard data representations may be associated with subscription or feed information that may be, in some implementations, associated with the feed data 550. Such information may be useful, for example, to transfer references to data, to represent feeds of data, to enable subscriptions to data or feeds, and so on. In one example, item data may be provided using, for example, the structured data 520, and information about a feed that may be used to update the item data may be provided using the feed data 550. For example, an initial set of contacts might be provided using the structured data 520, and information in the feed data 550 may be provided to enable an application to later update the contacts initially provided using the structured data. In another example, the feed data may refer to some other data or information—that is, for example, the feed data may refer to data that is not transferred in the structured data 520. For example, the feed data may refer to one or more RSS, Atom, or other feeds that contain additional or other information. The information referred to by the feed data may be related to or associated with the data included elsewhere in the clipping representation or clipboard data representation or may refer to data that is not included or associated with the clipping representation or clipboard data representation. Note also that references may be represented and communicated in other fashions that do not use feed references in feed data. For example, a reference might be represented as an item reference in a structured data item, as has been described previously.

Feed data may be represented in multiple ways, including, for example, in a manner similar to the following:

| | |
|---|---|
| <lc:feeds> | 0 or 1 elements |
| <lc:feed> | 1 or more elements |
| <lc:feeditems> | 0 or 1 elements |
| <lc:feeditem> | 0 or more elements |
| </lc:feeditems> | |
| </lc:feed/> | |
| </lc:feeds> | |

When represented like this, the “feeds” element may correspond to the feed data 550, the “feed” element may correspond to the feed 1 560 and feed N 562, the “feeditems” element may correspond to the feed items 1 564 and feed items N 568, and the “feeditem” element may correspond to the feed item 566 and feed item N 567.

A feed, like feed 1 560 and feed N 562, may have associated information about the feed. A feed may be associated with some or all of the “type”, “ref”, “description”, and “authtype” attributes, as well as other attributes. The “type” attribute may represent the type of data that exists at the location specified, for example, by the “ref” attribute. For example, the “type” attribute may include values such as “RSS”, “Atom”, and so on, or other values. Generally, a wide variety of feed types may be used, depending upon, for example, the capabilities of the endpoints. For example, some implementations may support RSS, other implementations may support RSS and also support extensions to RSS to implement other functionality, and so on. For example, some endpoints may support SSE to enable synchronization of data using RSS or other feed types. The “ref” attribute may represent a specific reference or address associated with the feed, like a URL. In some implementations, this reference may be the location of the feed itself. The “description” may represent some user-specified data associated with the feed. Finally, the “authtype” attribute may represent some type of authentication technique or techniques that may or must be used when accessing the feed.

Each feed may contain some number of sets of feed items, such as feed items 1 564 and feed items N 568. These may be represented in some cases by one or more “feeditems” elements. In turn, a set of feed items may contain some number of feed items, which might be represented using “feeditem” elements.

A set of feed items may be associated with the “contenttype”, “type”, and “xpath” attributes, as well as other attributes. The “contenttype” attribute may represent the content type of data for the contained “feeditem” elements. For example, similar to the structured data, this attribute may contain data defined by IANA, like “text/calendar”, “application/xhtml+xml”, and so on. The “type” attribute may represent a schema or format type of the data for the contained “feeditem” elements. This may be useful, like before and for example, if an IANA format identifier provided may not be sufficient to completely determine the type. For example, when the “contenttype” attribute has a value of “text/calendar” there may be sufficient information to determine that the data associated with a “feeditem” element is formatted using the iCal standard. In contrast, when the “contenttype” attribute has a value such as “application/xhtml+xml”, additional information may be necessary to determine the format of the data in the “feeditem” element. For example, in this case, the “type” attribute might have a value of “vevent”, which might indicate that the data is formatted using the hCalendar standard.

The “xpath” attribute may represent a query—perhaps using the XPath standard, but also represented using some other query language or standard—that returns or otherwise identifies data items from the feed. For example, if a feed is retrieved using the “ref” attribute of the parent “feed” element, in some cases the query represented by the “xpath” attribute may be executed against the contents of the retrieved feed to identify particular data items in the feed. This may enable the feed to contain a variety of data, only some of which may be relevant for or associated with the clipboard data, and still enable the clipboard data to be associated directly with the relevant data. In addition, this may enable the relevant portions of the data to be changed, perhaps at some later time, by only changing the value of this attribute; the actual data in the feed would not necessarily need to change. In implementations that do not use the “xpath” attribute, or a similar type of attribute or query, all of the data associated with the feed may be relevant to, for example, a subsequent update or data retrieval operation.

Similar to with the structured data discussed previously, in some implementations, when multiple formats are provided, it may be useful to order the formats in some fashion. For example, “higher fidelity” formats—formats that may provide more data, for example—might be ordered before “lower fidelity” formats that do not provide as much data. As before, lower fidelity formats may be more widely accepted, and so still may be preferable for some uses, or for some applications, web pages, and so on.

A set of feed items may in turn be associated with or contain some number of “feeditem” elements, which may in some cases, enable information retrieved from the feed to be linked to “item” elements provided, for example, in the structured data 520. A “feeditem” element may be associated with an “id” attribute, or some other attribute or data, which may represent some type of identifier, perhaps a unique identifier, for the feed item. In implementations that do not use or include elements like the “feeditem” element, data may still be retrieved and used, but in some cases the data may not be linked to the structured data also provided with the clipboard data.

In at least some implementations, if there are multiple instances of feeds, like feed 1 560 and feed N 562, the ordering of “feeditem” elements beneath each feed may indicate that particular items correspond to each other. For example, in the case where there are two “feed” elements named X and Y, the first “feeditem” element associated with “feed” X may correspond to the first “feeditem” element associated with “feed” Y. Also, in clipboard data that has structured data 520, the ordering of “feeditem” elements may correspond to the ordering of “item” elements provided in the structured data 520.

An example clipboard data representation that uses feed data 550 is provided below, after the discussion of presentation data.

Finally, some clipping representations and clipboard data representations may be associated with presentation data, such as presentation data 580 and presentation format 1 590 and presentation format N 592. Such data may provide a formatted or display representation of data that may also be provided elsewhere in the clipboard data. For example, where the structured data 520 includes a contact, perhaps in the hcard or vcard formats, the presentation data may be associated with an instance of the same contact data represented using HTML, JPEG, or some other presentation data format. In many cases destination applications, web pages, or the like, that do not understand data in one or more structured data formats may still understand a display representation, like HTML or JPEG, and so may still be able to at least display or present the clipboard data.

Presentation may be represented in multiple ways, including, for example, in a manner similar to the following:

| | |
|---|---|
| <lc:presentations> | 0 or 1 elements |
| <lc:format/> | 1 or more elements |
| </lc:presentations> | |

When represented like this, the “presentations” element may correspond to the presentation data 580, and the “format” element may correspond to the presentation format 1 590 and presentation format N 592.

The presentation data 580 may be associated with some number of presentation formats. Each presentation format, perhaps represented by a “format” element, may be associated with some or all of the “contenttype”, “type”, “encoding”, “description”, and “ref” attributes, as well as other attributes. The “contenttype” attribute may represent the content type of data, for example, for a CDATA section associated with this format. For example, this attribute may contain data defined by IANA, like “application/xhtml+xml”, and the like. The “type” attribute may represent a schema or format type of the data for the format. Like before, this may be useful, for example, if an IANA format identifier provided may not be sufficient to completely determine the type. The “encoding” attribute may represent how the data associated with, for example, a CDATA section is encoded. The “description” attribute may represent data defined by the user or application. Finally, the “ref” attribute may contain a reference, for example a URL, associated with the item.

Similar to with structured data, a “format” element may also contain data itself. For example, when using XML, if the data can be represented as well-formed XML data that uses the UTF-8 encoding, then the XML corresponding to the data may be appended as a child of the “format” element. In some other cases, for example when the data may not be represented as well-formed UTF-8 XML data, the data may reside in a CDATA section for the “format” element, optionally encoded in the format described by the “encoding” attribute.

As just one example, suppose clipboard data is desired that represents contact information in the hCard format, an RSS feed associated with the contact information—so the contact information can be updated at some later point in time, for example—and an HTML representation of the contact data—perhaps useful, for example, if a destination of the clipboard data does not understand the hCard format.

With such an example, the hCard contact data might be represented as follows:

```
<div class=‘vcard’>
  <span class=‘fn n’>
    <span class=‘given-name’>John</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
<div class=‘vcard’>
  <span class=‘fn n’>
    <span class=‘given-name’>George</span>
    <span class=‘family-name’>Doe</span>
  </span>
  <div class=‘adr’>
    <span class=‘type’>work</span> address:
    <span class=‘street-address’>1 Microsoft Way</span>,
    <span class=‘locality’>Redmond</span>,
    <span class=‘region’>WA</span>
    <span class=‘postal-code’>98052</span>
  </div>
  <div class=‘tel’>
    <span class=‘type’>work</span>
    <abbr class=‘type’ title=‘voice’> phone: </abbr>
    <span class=‘value’>+1-425-555-1212</span>
  </div>
</div>
```

In the same example, the RSS data might be represented as follows:

```
<?xml version=“1.0” encoding=“utf-8” ?>
<rss version=“2.0”>
  <channel>
    <title>My Friends </title>
    <link>http://localhost/FriendsFeed.ashx</link>
    <pubDate>Wed, 15 Mar 2006 09:05:43 -0800</pubDate>
    <lastBuildDate>Wed, 15 Mar 2006 09:05:43 -0800</lastBuildDate>
    <item>
      <title>John Doe</title>
      <description>
        <![CDATA[
          <div class=‘vcard’>
            <span class=‘fn n’>
              <span class=‘given-name’>John</span>
              <span class=‘family-name’>Doe</span>
            </span>
            <div class=‘adr’>
              <span class=‘type’>work</span> address:
              <span class=‘street-address’>1 Microsoft Way</span>,
              <span class=‘locality’>Redmond</span>,
              <span class=‘region’>WA</span>
            <span class=‘postal-code’>98052</span>
          </div>
          <div class=‘tel’>
            <span class=‘type’>work</span>
            <abbr class=‘type’ title=‘voice’> phone: </abbr>
            <span class=‘value’>+1-425-555-1212</span>
          </div>
        </div>
        ]]>
      </description>
    <enclosure
url=“http://server/SIS/contact.vcf?puid=1688852012477191&roid=
4EB2576478DA9846A06EFCC12FFC0185”/>
  </item>
  <item>
    <title>George Doe</title>
    <description>
      <![CDATA[
        <div class=‘vcard’>
          <span class=‘fn n’>
            <span class=‘given-name’>George</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’>98052</span>
          </div>
          <div class=‘tel’>
            <span class=‘type’>work</span>
            <abbr class=‘type’ title=‘voice’> phone: </abbr>
            <span class=‘value’>+1-425-555-1212</span>
          </div>
        </div>
      ]]>
    </description>
    <enclosure url=“
http://server/SIS/contact.vcf?puid=1688852012477191&roid=
0B69B846ED7E2241AE4F6773EA749183”/>
  </item>
  </channel>
</rss>
```

And in the same example, the HTML data for the contact information might be represented as follows:

```
<html>
  <body>
    <table>
      <tr>
        <th><b>Fullname</b></th>
        <th><b>Street Address</b></th>
        <th><b>City</b></th>
        <th><b>State</b></th>
        <th><b>Zip</b></th>
        <th><b>phone</b></th>
      </tr>
      <tr>
        <td>John Doe</td>
        <td>1 Microsoft Way </td>
        <td>Redmond</td>
        <td>WA</td>
        <td>98052</td>
        <td>+1-425-555-1212</td>
      </tr>
      <tr>
        <td>George Doe</td>
        <td>1 Microsoft Way </td>
        <td>Redmond</td>
        <td>WA</td>
        <td>+1-425-555-1212</td>
      </tr>
    </table>
  </body>
</html>
```

Given all of these data representations, a corresponding clipboard data representation might consist of the following data:

```
<?xml version=“1.0” encoding=“utf-8” ?>
<liveclipboard version=“0.92”
xmlns:lc=“http://www.microsoft.com/schemas/liveclipboard”>
<lc:data>
  <lc:format type=“vcard” contenttype=“application/xhtml+xml”>
    <lc:item>
      <div class=‘vcard’>
        <span class=‘fn n’>
          <span class=‘given-name’>John</span>
          <span class=‘family-name’>Doe</span>
        </span>
        <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
      <lc:item>
        <div class=‘vcard’>
          <span class=‘fn n’>
            <span class=‘given-name’>George</span>
            <span class=‘family-name’>Doe</span>
          </span>
          <div class=‘adr’>
            <span class=‘type’>work</span> address:
            <span class=‘street-address’>1 Microsoft Way</span>,
            <span class=‘locality’>Redmond</span>,
            <span class=‘region’>WA</span>
            <span class=‘postal-code’> 98052</span>
          </div>
          <div class=‘tel’>
            <span class=‘type’>work</span>
            <abbr class=‘type’ title=‘voice’> phone: </abbr>
            <span class=‘value’>+1-978-555-1212</span>
          </div>
        </div>
      </lc:item>
    </lc:format>
  </lc:data>
  <lc:feeds>
    <lc:feed type=“RSS” ref=“http://localhost/FriendsFeed.ashx” description=“My Friends”
authtype=“none”>
      <lc:feeditems type=“vcard” contenttype=“application/xhtml+xml”
xpath=“/rss/channel/item/description”>
      <lc:feeditem
id=“http://server/SIS/contact.vcf?puid=1688852012477191&amp;roid=4EB2576478DA9846A06EF
CC12FFC0185”/>
      <lc:feeditem
id=“http://server/SIS/contact.vcf?puid=1688852012477191&amp;roid=0B69B846ED7E2241AE4F6
773EA749183”/>
      </lc:feeditems>
    </lc:feed>
  </lc:feeds>
  <lc:presentations>
    <lc:format contenttype=“text/html”>
      <table>
        <tr>
          <th>Fullname</th>
          <th>Street Address</th>
          <th>City</th>
          <th>State</th>
          <th>Zip</th>
          <th>Phone</th>
        </tr>
        <tr>
          <td>John Doe</td>
          <td>1 Microsoft Way </td>
          <td>Redmond</td>
          <td>WA</td>
          <td>+1-425-555-1212</td>
        </tr>
        <tr>
          <td>George Doe</td>
          <td>1 Microsoft Way </td>
          <td>Redmond</td>
          <td>WA</td>
          <td>+1-425-555-1212</td>
        </tr>
      </table>
    </lc:format>
  </lc:presentations>
</liveclipboard>
```

It should be noted that although portions of the clipping representation format described with reference to FIG. 5 refer to a clipboard—for example, including the clipboard data 510—that the clipping representations described with reference to FIG. 5 may in some implementations be transferred, stored, and otherwise manipulated without using a clipboard. As just one example, an application might create a create a clipping representation that conforms to the formats described with reference to FIG. 5 and might transfer such a clipping representation to a clipbook application using communication means that do not include a computer-implemented clipboard. Such communication means might include, as introduced previously, files or file-like storage, inter-process communications, one or more networks, or other communication means.

### Example Computing Environment

Turning now to FIG. 6, this figure and the related discussion are intended to provide a brief and general description of an exemplary computing environment in which the various technologies described herein may be implemented. Although not required, the technologies are described herein, at least in part, in the general context of computer-executable instructions, such as program modules that are executed by a controller, processor, personal computer, or other computing device, such as the computing device 600 illustrated in FIG. 6.

Generally, program modules include routines, programs, objects, components, user interfaces, data structures, and so on, that perform particular tasks, display particular information, or implement particular abstract data types. Operations performed by the program modules have been described previously with the aid of one or more block diagrams and operational flowcharts.

Those skilled in the art can implement the description, block diagrams, and operational flows in the form of computer-executable instructions, which may be embodied in one or more forms of computer-readable media. As used herein, computer-readable media may be any media that can store or embody information that is encoded in a form that can be accessed and understood by a computer. Typical forms of computer-readable media include, without limitation, both volatile and nonvolatile memory, data storage devices, including removable and/or non-removable media, and communications media.

Communication media embodies computer-readable information in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communications media includes wired media such as a wired network or direct-wired connection, and wireless media such as acoustic, RF, infrared and other wireless media.

The computing device 600 illustrated in FIG. 6, in its most basic configuration, includes at least one processing unit 602 and memory 604. In some implementations, the computing device 600 may implement all or part of, for example, a computer system that might be one of the server endpoint 410, endpoint A 420, endpoint B 430, or endpoint C 440, all previously described with reference to FIG. 4. In some implementations, the processing unit 602 may be a general purpose central processing unit (CPU), as exists, for example, on a variety of computers, including desktop and laptop computers. Depending on the exact configuration and type of computing device, the memory 604 may be volatile (such as RAM), non-volatile (such as ROM, flash memory, and so on), or some combination of the two. This most basic configuration is illustrated in FIG. 6 by dashed line 606. Additionally, the computing device 600 may also have additional features and functionality. For example, the computing device 600 may also include additional storage (removable and/or non-removable) including, but not limited to, magnetic or optical disks or tape. Such additional storage is illustrated in FIG. 6 by the removable storage 608 and the non-removable storage 610.

The computing device 600 may also contain one or more communications connection(s) 612 that allow the computing device 600 to communicate with other devices and services. For example, the computing device might have one or more connections to other computing devices to synchronize or exchange clipping data, such as the connections between, for example, the server endpoint 410 and endpoint A 420, previously described with reference to FIG. 4. The computing device 600 may also have one or more input device(s) 614 such as an image input devices like cameras or scanners, keyboards, mice, pens, voice input devices including microphone arrays, touch input devices, and so on. One or more output device(s) 616 such as a display, speakers, printer, and so on, may also be included in the computing device 600.

Those skilled in the art will appreciate that the technologies described herein may be practiced with computing devices other than the computing device 600 illustrated in FIG. 6. For example, and without limitation, the technologies described herein may likewise be practiced in hand-held devices including mobile telephones and PDAs, multiprocessor systems, microprocessor-based or programmable consumer electronics, network PCs, minicomputers, mainframe computers, and the like. Each of these computing devices may be described, at some level of detail, by the system of FIG. 6, or may be described differently.

The technologies described herein may also be implemented in distributed computing environments where operations are performed by remote processing devices that are linked through a communications network. In a distributed computing environment, program modules may be located in both local and remote devices.

While described herein as being implemented in software, it will further be appreciated that the technologies described herein may alternatively be implemented all or in part as hardware, firmware, or various combinations of software, hardware, and/or firmware.

Although some particular implementations of methods and systems have been illustrated in the accompanying drawings and described in the foregoing text, it will be understood that the methods and systems shown and described are not limited to the particular implementations described, but are capable of numerous rearrangements, modifications and substitutions without departing from the spirit set forth and defined by the following claims.

What is claimed is:

1. A method, comprising:
indicating data to be added to a clipbook application;
identifying a clipping representation of the data wherein the clipping representation is capable of storing structured data, feed data, and presentation data; and
adding the clipping representation of the data to the clipbook application.

2. The method of claim 1, further comprising:
specifying a category associated with the clipping representation of the data and storing the category associated with the clipping representation of the data.

3. The method of claim 2 wherein the category is not pre-defined by the clipbook application and is specified when the clipping representation is added to the clipbook application.

4. The method of claim 1 wherein a first entity performs the indicating operation, and further comprising:
specifying a second entity with whom the clipping representation of the data is to be shared, where the first entity and the second entity are not the same.

5. The method of claim 4, further comprising:
specifying that the second entity may read the clipping representation of the data and that any changes to the clipping representation of the data made by the second entity will not be incorporated by the first entity.

6. The method of claim 4, further comprising:
specifying that the second entity may make a change to a second instance of the clipping representation of the data associated with the second entity after which the clipbook application will incorporate the change into the clipping representation of the data.

7. The method of claim 1 wherein the indicating is associated with copying one of the data and the clipping representation of the data to a computer-implemented clipboard.

8. The method of claim 1 wherein the clipping representation of the data conforms to a Live Clipboard schema.

9. The method of claim 1, further comprising:
indicating a second clipping representation of the data to be transferred from the clipbook application;
specifying a destination location; and
transferring the second clipping representation of the data to the destination location.

10. The method of claim 9 wherein the indicating the second clipping representation of the data operation further comprises selecting a user interface representation of the second clipping representation of the data in the clipbook application.

11. The method of claim 9 wherein the indicating the second clipping representation of the data operation further comprises copying the second clipping representation of the data to a computer-implemented clipboard.

12. The method of claim 9 wherein the transferring the second clipping representation of the data operation further comprises pasting the second clipping representation of the data from a computer-implemented clipboard to the destination location.

13. The method of claim 1 wherein the indicating operation and the identifying operation are performed by the clipbook application by querying a user for the data.

14. The method of claim 1 wherein a user performs the indicating operation, and further comprising:
synchronizing the clipping representation of the data from an endpoint associated with the user to a second endpoint associated with the user, where the endpoint and the second endpoint are not the same.

15. The method of claim 1 wherein a user performs the indicating operation, and further comprising:
synchronizing the clipping representation of the data from a first endpoint associated with the user to a second endpoint associated with a second user and thereby creating a second clipping representation of the data maintained on the second endpoint, where the user and the second user are not the same, and the first endpoint and the second endpoint are not the same.

16. The method of claim 15, further comprising:
making a change to the second clipping representation of the data on the second endpoint;
synchronizing one of the changed second clipping representation of the data and the change to the first endpoint; and
updating the clipping representation of the data on the first endpoint so that it incorporates the change.

17. A system, comprising:
an originating endpoint comprising:
an input device configured to enable a user to indicate clipping data to be added to a clipbook application implemented by a clipping module;
the clipping module configured to:
store the clipping data; and
synchronize the clipping data with a destination endpoint; and
the destination endpoint comprising:
a second clipping module configured to:
receive the clipping data from the originating endpoint; and
add the clipping data to a second clipbook application implemented by the second clipping module.

18. The system of claim 17 wherein the originating endpoint and the destination endpoint are connected and transfer the clipping data in a peer-to-peer fashion without requiring intermediation by a server endpoint.

19. The system of claim 17 wherein the originating endpoint is implemented on a client computer associated with a single user and the destination endpoint is implemented on a server computer that also receives and adds at least a second piece of clipping data from at least one other endpoint that is not the same as the originating endpoint.

20. A user interface for displaying a structured data item in a computer system, comprising:
a visualization of the structured data item that displays in the user interface at least a portion of data associated with the structured data item;
a category displayed in the user interface and associated with the structured data item; and
wherein one or more computer-executable instructions associated with the user interface and executed by the computer system implement the following operations:
indicating second data to be added to a clipbook application;
specifying the category associated with the second data;
identifying a clipping representation of the second data that includes the structured data item;
adding the clipping representation of the second data to the clipbook application; and
displaying the visualization.
